(19) United States
(12) Patent Application Publication
(10) Pub. No.: US 2026/0098184 A1
(43) Pub. Date: Apr. 9, 2026

(54) BACK ADHESIVE STICKER

(71) Applicant: NINGBO HYDERON HARDWARE CO.,LTD., YUYAO (CN)

(72) Inventor: LIFENG ZHANG, YUYAO (CN)

(21) Appl. No.: 19/005,509

(22) Filed: Dec. 30, 2024

(30) Foreign Application Priority Data
Oct. 8, 2024 (CN) 202411390188.5

(51) Int. Cl. C09J 7/21; A47G 29/087

(52) U.S. Cl. CPC C09J 7/21; A47G 29/087

(57) ABSTRACT

A back adhesive sticker includes an adhesive layer, one side of the back adhesive is compounded with a layer of adhesive and/or removable film, and the other side of the back adhesive is adhered with an anti-adhesive layer. The anti-adhesive layer is adhered to one side of the back adhesive, and the film is compounded on the other side of the back adhesive. And then, according to the actual use condition, a hook can be adhered to the film or when the back adhesive is torn off from the adhered object, the back adhesive will not damage the surface of the adhered object, nor will damage the single-sided adhesive of the back adhesive.

### TECHNICAL FIELD

The present disclosure relates to the technical field of adhesive and fixation, in particular to a back adhesive sticker.

### BACKGROUND OF THE INVENTION

If an article, such as an ornament or a hook, is to be fixed in a designated area, it is generally fixed by a back adhesive. As shown in FIG. 1, the existing back adhesive sticker comprises a hook 1 and a back adhesive 2, wherein the hook 1 is permanently adhered to the back adhesive 2 or integrated with the back adhesive 2, and the release paper is covered on the back adhesive 2 so as to prevent the back adhesive from adhering any object randomly before use.

At present, the majority of the back adhesive door stoppers and back adhesive buffer pads on the market do not laminated with film at the back adhesive 2, the product is not firmly adhered, traces are left after being taken down, thus the product is not suitable for surfaces made of various materials, and cannot be washed and reused.

### SUMMARY OF THE INVENTION

It is an object of the present disclosure to provide a back adhesive sticker to solve the above-mentioned problems in the background art.

In order to achieve the above object, the present disclosure provides the following technical scheme:

The present disclosure relates to a back adhesive sticker which comprises a back adhesive, wherein one side of the back adhesive is compounded with a layer of adhesive and/or a removable film, and the other side of the back adhesive is adhered with an anti-adhesive layer.

Preferably, the back adhesive is a single-sided adhesive.

Preferably, the back adhesive is a double-sided adhesive.

Preferably, the film is prepared by applying an epoxy resin adhesive on a cotton paper substrate, a PET substrate, a PC substrate or a PET foam.

Preferably, the long-term temperature resistant range of the film is −20° C.˜100° C.

Preferably, the film is adhered with a hook or a back adhesive.

Preferably, the anti-adhesive layer is release paper or release film.

Preferably, the area of the film is equal to or smaller than the area of the anti-adhesive layer.

Compared with the prior art, the present disclosure has the advantages that:

The product disclosed by the present disclosure is simple in structure and convenient to produce, and the rigidity of the back adhesive (pasting) is improved by compounding a layer of film on the back adhesive.

According to the present disclosure, the rigidity of the adhesive tape is improved, the bearing load is strong, the adhesion is firm, no trace is left when the hook is taken off from the film, the glue of the film can be cleaned, the product can be repeatedly used, and the back adhesive sticker is economical and environment-friendly.

### BRIEF DESCRIPTION OF THE DRAWINGS

FIG. 1 is a schematic diagram of a back adhesive sticker with a hook in the prior art;

FIG. 2 is a schematic structural diagram of a back adhesive sticker with a hook according to the present disclosure;

FIG. 3 is a left side view of FIG. 2 in accordance with the present disclosure;

FIG. 4 is a schematic diagram of the structure of the present disclosure with a hook removed.

In the Figure: 1. Hook; 2. Back adhesive; 3. Release paper or release film; 4. Film.

### EMBODIMENT

The technical solutions in the embodiments of the present disclosure will be clearly and completely described in the following with reference to the drawings in the embodiments of the present disclosure. Obviously, the described embodiments are only a part of the embodiments of the present disclosure, not all of the embodiments. Based on the embodiments of the present disclosure, all other embodiments obtained by the ordinary technical personnel in the art without creative labor are within the protection scope of the present disclosure.

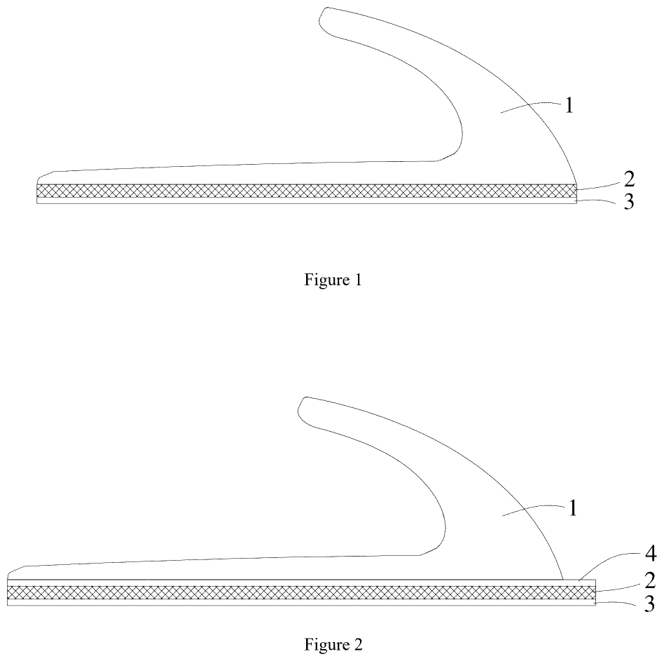

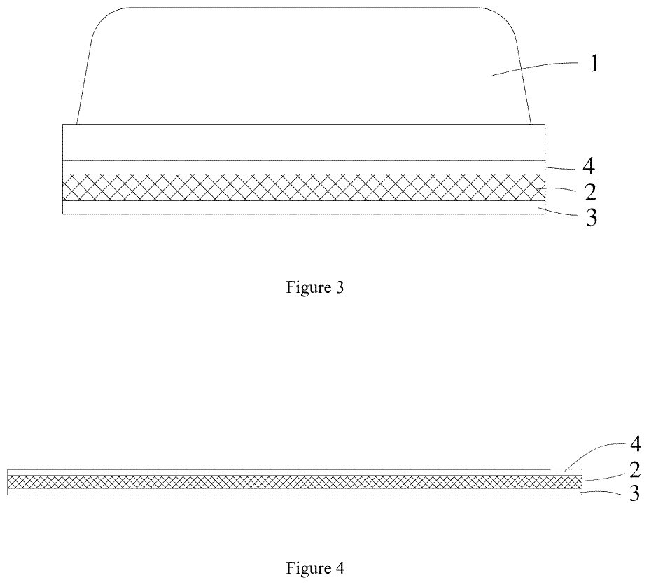

Referring to FIGS. 1-4, the present disclosure provides a technical solution:

A back adhesive sticker comprises a back adhesive 2, wherein one side of the back adhesive 2 is compounded with a layer of adhesive and/or removable film 4, and the other side of the back adhesive 2 is adhered with an anti-adhesive layer.

Specifically, the back adhesive 2 is a single-sided adhesive.

Specifically, the back adhesive 2 is a double-sided adhesive.

Specifically, the film 4 is prepared by applying an epoxy resin adhesive on a cotton paper substrate, a PET substrate, a PC substrate or a PET foam.

Specifically, the film 4 has a long-term temperature resistant range of −20° C.˜100° C., and has the effect of no residual adhesive after long-term adhering.

Specifically, the film 4 is adhered with a hook 1 or a back adhesive 2.

Specifically, the anti-adhesive layer is release paper or release film 3.

Specifically, the area of the film 4 is equal to or smaller than the area of the release layer.

According to the present disclosure, as shown in FIG. 2, a layer of film 4 is compounded on the back adhesive 2 to develop a single-sided adhesive sticker which is heavy in bearing capacity; when the back adhesive is torn off from the adhered object, the back adhesive will not damage the surface of the adhered object, nor will damage the single-sided adhesive of the back adhesive. Thus, by adoption of the present disclosure, the problems that the majority of the hooks, the back adhesive door stoppers and the back adhesive buffer pads on the current market not laminating with the back adhesive, resulting in unstable product adhesion and leaving traces when being removed, not suitable for surfaces made of various materials, and cannot be washed and reused, are solved.

In the present disclosure, when the hook 1, the back adhesive stopper and the back adhesive buffer pads are adhered with adhesive, a layer of film 4 is added in the middle for compounding' and the reason why compounded film is so-called as a compounded film product is that the main purpose of the compounded is to facilitate the removal of the product from the adhered object and prevent damage to the surface of the adhered object.

The back adhesive sticker product formed by compounding a layer of film 4 on the back adhesive 2 has the following advantages:

1. Pasting firmly, without any traces when being taken down.

2. It is applicable to the surface made of various materials: the adhesive is applicable for latex paint wall surface, ceramic tile surface, smooth and flat wallpaper surface, and various paint furniture surfaces, etc.

3. Reusable: the adhesive can be cleaned and the product can be reused, which is economical and environment-friendly.

4. Strong bearing load.

5. Easy to install and take down.

An anti-adhesive layer is adhered to one side of the back adhesive 2, a film 4 is compounded on the other side of the back adhesive 2, and then a hook 1 or the back adhesive 2 can be adhered on the film 4 according to actual use conditions.

Due to the softness of all double-sided adhesive tapes on the market, they lack rigidity when being pulled or torn up, making them easy to tear, not strong in load bearing, easy to peel off, and are easy to leave traces on the surfaces of the adhered objects.

By adoption of the back adhesive sticker product, the rigidity of the double-sided adhesive sticker (back adhesive 2) can be enhanced through the compounded film 4, the rubber sheet cannot be torn during stripping; and by matching with special adhesive, the back adhesive sticker will not damage various wall surfaces, and is convenient to remove.

In the present disclosure, the part not described is the prior art.

Although the embodiments of the present disclosure have been shown and described, it will be understood by those skilled in the art that various changes, modifications, substitutions and alterations may be made to these embodiments without departing from the principles and spirit of the present disclosure, and the scope of the present disclosure is defined by the appended claims and their equivalents.

What is claimed is:

1. A back adhesive sticker, comprising a back adhesive, wherein one side of the back adhesive is compounded with a layer of adhesive and/or removable film, and the other side of the back adhesive is adhered with an anti-adhesive layer.

2. The back adhesive sticker according to claim 1, wherein the back adhesive is a double-sided adhesive.

3. The back adhesive sticker according to claim 1, wherein the back adhesive is a single-sided adhesive.

4. The back adhesive sticker according to claim 1, wherein the film is prepared by applying an epoxy resin adhesive on a cotton paper substrate, a PET substrate, a PC substrate or a PET foam.

5. The back adhesive sticker according to claim 4, wherein the long-term temperature resistant range of the film is −20° C.˜100° C.

6. The back adhesive sticker according to claim 1, wherein the film is adhered with a hook or back adhesive.

7. The back adhesive sticker according to claim 1, wherein the anti-adhesive layer is a release paper or a release film.

8. The back adhesive sticker according to claim 1, wherein the area of the film is equal to or smaller than the area of the anti-adhesive layer.
